(19) United States
(12) Patent Application Publication
(10) Pub. No.: US 2006/0196447 A1
(43) Pub. Date: Sep. 7, 2006

(54) Pet diaper system

(76) Inventors: Daphne Poh-Beyerlein, Ann Arbor, MI (US); Fred G. Beyerlein, Ann Arbor, MI (US)

Correspondence Address: DAPHNE POH-BEYERLEIN, 678 BOSTON COURT, ANN ARBOR, MI, 48103, US

(21) Appl. No.: 11/364,921

(22) Filed: Mar. 1, 2006

Related U.S. Application Data
(60) Provisional application No. 60/658,697, filed on Mar. 4, 2005.

(51) Int. Cl. A01K 23/00

(52) U.S. Cl. 119/869

(57) ABSTRACT

An animal diaper system retains a disposable absorbent pad against an animal. A cross support has a girth portion and a longitudinal portion, wherein the girth portion has attachable distal ends for securing the girth portion around the animal. The longitudinal portion extends from the girth portion and has a tail end and a front end for fitting along the underside of the animal. The longitudinal portion comprises a pad-receiving area between the tail end and the girth portion. Rear straps are adapted to pass from the tail end between the hind legs of the animal and around respective sides of the tail of the animal to attach to the girth portion at the top side of the animal. A pair of suspender straps are adapted to pass from the front end through the front legs around respective sides of the neck of the animal to attach to the girth portion at the top side of the animal. The suspender straps have attachable intermediate sections for joining together at a position along the top side of said animal between the neck and the girth portion.

### CROSS REFERENCE TO RELATED APPLICATIONS

This application claims priority to co-pending U.S. provisional application Ser. No. 60/658,697, filed Mar. 4, 2005.

### BACKGROUND OF THE INVENTION

The present invention relates to a diaper system for pets (e.g., dogs and cats) having a cross support for receiving a disposable absorbent pad and having front and rear straps to secure around the animal's body while allowing them ease of movement.

Pet diapers present in today's market are rigid, bulky, and cumbersome, while requiring too many time-consuming adjustments to fit them to the animal. The known attachment arrangements interfere with limb motion so that the dog or cat wearing them does not have ease of movement. Furthermore, prior systems have not taken into consideration the uncooperative nature of dogs and cats which makes them unlikely to stand still for the owner to fit the diaper on them properly. Most pets do not like foreign objects on their bodies and they will move around and make every attempt to dislodge it. The less obtrusive the diaper system is to the pet, the more likely it will be tolerated. Yet, a robust attachment must be achieved in order to ensure that the absorbent diaper remains in place.

Conventional diapers have been made too bulky and too warm for the pet to have it on for an extended time. U.S. Pat. No. 4,813,949 illustrates a dog diaper with a tail band brought over the rump and fastened to the body band ends. Such a system is not well retained, and the diaper may easily slip off once the dog or cat starts moving around. U.S. Pat. No. 4,996,949 shows a disposable dog diaper that is wrapped around the lower body of the dog. A drawback with the '949 patent is that the diaper can rotate around the lower body. When this happens, the absorbent material that is affixed on the body sheet is moved to the spine portion of the body away from the excretory organs. U.S. Pat. No. 5,555,847 illustrates a complicated dog diaper system with a z-fold diaper and straps passing forward and around the dog's neck. The complicated arrangement of this system makes it time-consuming and difficult to mount to the animal and results in overly restricted movement and discomfort for the animal. U.S. Pat. Nos. 6,142,105 and 6,368,313 are other examples of complicated diaper systems subject to the foregoing disadvantages.

### SUMMARY OF THE INVENTION

The invention provides a simple, nonobtrusive diaper harness which is easy to fit to an animal, does not interfere with limb movement, leaves most of the animal uncovered to avoid overheating, and uses readily available disposable absorbent pads of the type available for human use (e.g., sanitary napkins and incontinence pads) to reduce the costs of using the diaper system.

In one aspect of the invention, an animal diaper system retains a disposable absorbent pad against an animal. A cross support has a girth portion and a longitudinal portion, wherein the girth portion has attachable distal ends for securing the girth portion around the animal. The longitudinal portion extends from the girth portion and has a tail end and a front end for fitting along the underside of the animal. The longitudinal portion comprises a pad-receiving area between the tail end and the girth portion. Left and right rear straps connect to the tail end and have attachable distal ends. The rear straps are adapted to pass between the hind legs of the animal and around respective sides of the tail of the animal to attach to the girth portion at the top side of the animal. A pair of suspender straps are connected to the front end and have attachable distal ends. The suspender straps are adapted to pass around respective sides of the neck of the animal to attach to the girth portion at the top side of the animal. The suspender straps have attachable intermediate sections for joining together at a position along the top side of said animal between the neck and the girth portion.

### BRIEF DESCRIPTION OF THE DRAWINGS

FIG. 1 is a plan view of the interior side of the pet diaper system laid out prior to fitting to an animal.

FIG. 2 is a plan view of the exterior side of the diaper system of FIG. 1.

FIG. 3 is a top view of the diaper system of FIG. 1 wherein the distal ends of girth portion have been attached to form a loop.

FIG. 4 is a top view of the diaper system of FIG. 3 wherein the distal ends of the front and rear straps have been attached to the girth portion.

FIGS. 5, 6, and 7 are side, top, and bottom views, respectively, of a dog wearing a pet diaper system of the type shown in FIG. 1.

FIG. 8 is a plan view of the interior side of an alternative embodiment of the pet diaper system.

FIGS. 9-13 are various views of a dog wearing a pet diaper system of the type shown in FIG. 8.

### DETAILED DESCRIPTION OF PREFERRED EMBODIMENTS

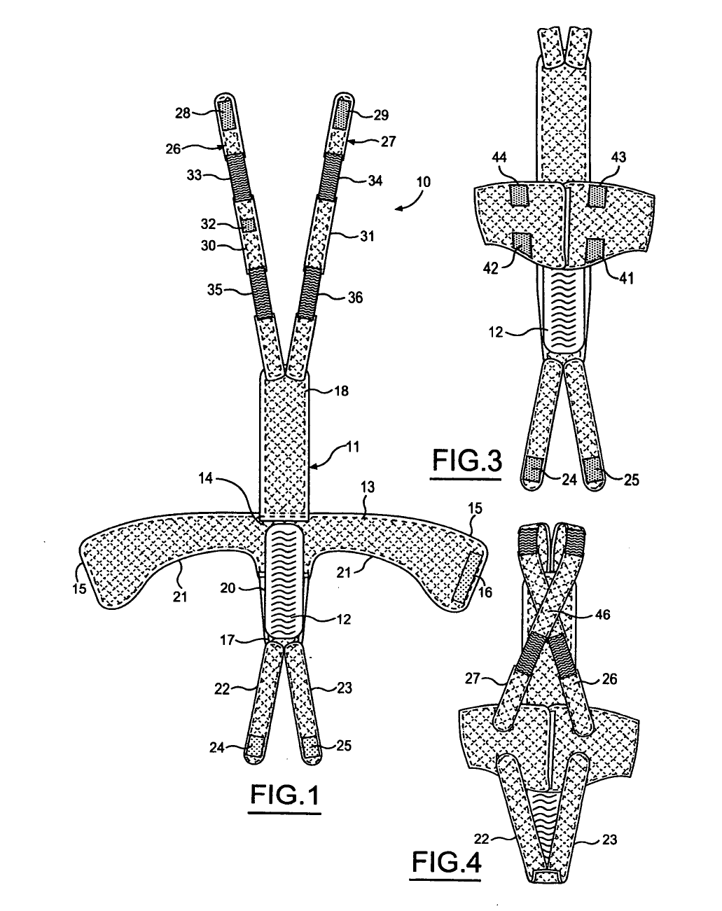

Referring now to FIG. 1, a pet diaper system 10 includes a cross support 11 that acts as a harness or webbing to retain an absorbent pad 12 against the body of the animal over the excretory organs. Cross support 11 includes a girth portion 13 and a longitudinal portion 14 that cross transversely underneath the animal. Cross support 11 may preferably be comprised of cotton quilted fabric but may also be made of any other conformable sheet material including synthetics, plastics, fabrics, or woven materials. Girth portion 13 and longitudinal portion 14 may be separate pieces sewn together as shown, or may be integrally formed as one piece. Preferably, longitudinal portion 14 comprises two pieces, one extending from the front and one from the back of girth portion 13 in order to avoid double thickness of material where the portions cross, which might otherwise cause too much stiffness depending upon the fabric used.

Girth portion 13 has attachable distal ends 15 on opposite sides of longitudinal portion 14. A hook and loop fastener 16 is mounted at the outside edge of one distal end 15, and may be comprised of Velcro® hook and loop fastener, for example. Alternatively, any other fasteners such as buttons, zippers, snaps, ties, or other garment closures could be used instead of hook and loop for any of the fasteners used herein.

Longitudinal portion 14 has a tail end 17 and a front end 18 such that longitudinal portion 14 can be fit along the underside of the animal. A pad-receiving area 20 between tail end 17 and girth portion 13 receives the disposable absorbent pad which is fixed in place by adhesive applied to the pad 12. The rear-facing end of girth portion 13 has a taper 21 which is adapted to provide a contour around the hind legs of the animal so that freedom of movement is uninhibited and pad 12 is accurately maintained in proper position. More specifically, girth portion 13 tapers outward from longitudinal portion 14 to attachable distal ends 15.

A pair of rear straps 22 and 23 project from tail end 17 of longitudinal portion 14 in a side-by-side relationship. Rear straps 22 and 23 may be sewn onto portion 14 or may be made integral with it. Preferably, the same material is used for straps 22 and 23 as is used for cross support 11. Left strap 22 and right strap 23 have attachable distal ends receiving hook and loop fasteners 24 and 25, respectively.

A pair of suspender straps 26 and 27 project from front end 18 of longitudinal portion 14 in a side-by-side relationship. Suspender straps 26 and 27 may be sewn onto portion 14 or may be made integral with it. Preferably, the same material is used for straps 26 and 27 as is used for cross support 11. Left suspender strap 26 and right suspender strap 27 have attachable distal ends receiving hook and loop fasteners 28 and 29, respectively. Intermediate sections 30 and 31 of straps 26 and 27 are also attachable by means of a hook and loop fastener 32. To accommodate a range of sizes of animals, suspender straps 26 and 27 may optionally include elastic band sections 33-36. Preferably, elastic bands are provided between intermediate sections 30 and 31 and their respective distal ends and between intermediate sections 30 and 31 and front end 18, but lesser or greater use of elastic sections can be employed with the present invention.

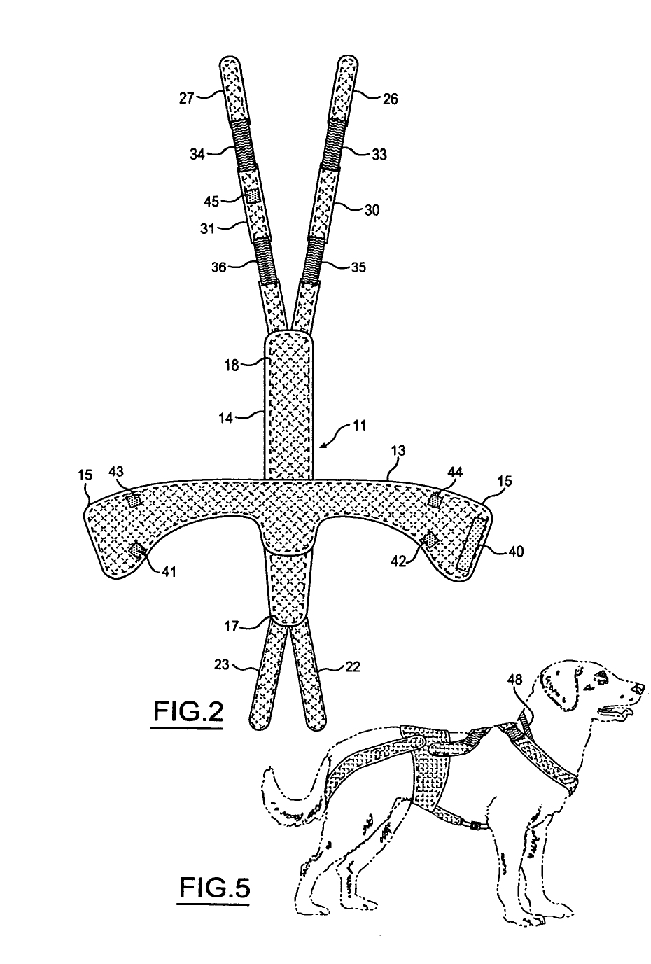

FIG. 2 shows the reverse (exterior) side of diaper system 10. On this side, girth portion 13 includes a hook and loop fastener 40 at one distal end 15 which is adapted to join with hook and loop fastener 16 on the other side of the other distal end 15. The exterior side of girth portion 13 also includes hook and loop fasteners 41 and 42 at the back edge, close to distal ends 15, for attaching with hook and loop fasteners 25 and 24, respectively, on rear straps 23 and 22. Hook and loop fasteners 43 and 44 at the front edge of girth portion 13, close to distal ends 15, attach with hook and loop fasteners 29 and 28, respectively, on suspender straps 27 and 26. Another hook and loop fastener 45 is mounted to intermediate portion 31 of suspender strap 27 for attaching with hook and loop fastener 32 on suspender strap 26.

FIG. 3 illustrates the manner in which distal ends 15 of girth portion 13 are attached by hook and loop fasteners 16 and 40 (as would be the first step in fitting the diaper system to an animal after a pad 12 has been applied). Hook and loop fasteners 41-44 are now in position on the top side (i.e., along the back or spine) of the animal substantially aligned with the hip and shoulder joints. In FIG. 4, rear straps 22 and 23 and front suspender straps 26 and 27 are attached in the final position. Note that suspender straps 26 and 27 preferably cross with fasteners 32 and 45 being attached at a crossover point 46.

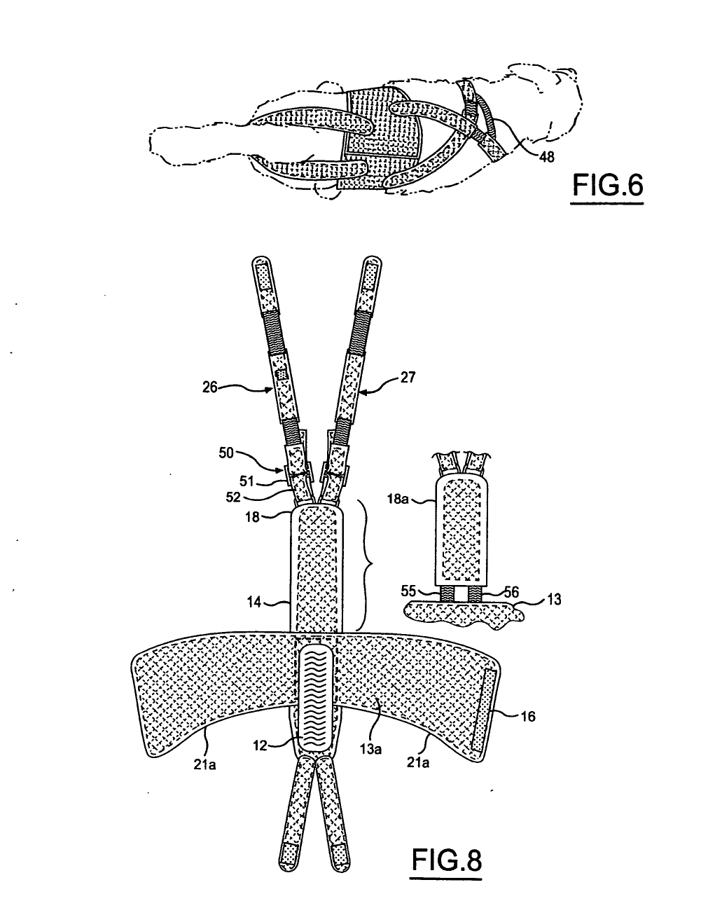

FIGS. 5 and 6 show how the disposable absorbent pad is robustly secured in the proper position on a dog while the harness itself has minimal interference with movement of any of the front legs, hind legs, neck, or shoulder. Consequently, the system of the present invention can be more easily and quickly fitted to the animal, and the animal is much more likely to tolerate its presence and not attempt to dislodge it. An elastic support strap 48 may be added as shown between the suspender straps for added support of larger size diaper systems for larger animals.

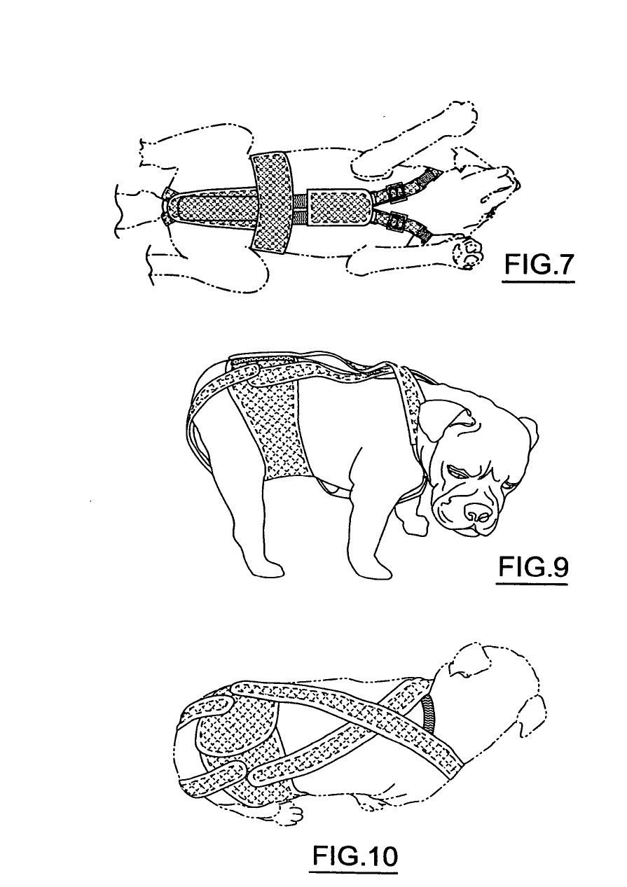

FIG. 7 is a bottom view of a dog wearing an alternative embodiment of the diaper system that will be described with reference to FIG. 8. To accommodate larger animals (e.g., a male dog or a heavier dog) a wider girth portion 13a may be provided. A taper 21a can also be appropriately modified to provide a diaper system intended for different classes of animal.

A further optional feature is comprised of an elastic band section within longitudinal section 14. Thus, elastic bands 55 and 56 may be provided between front end 18 and girth portion 13 as shown. Elastic bands may be connected to the cotton quilted fabric sections by sewing, for example.

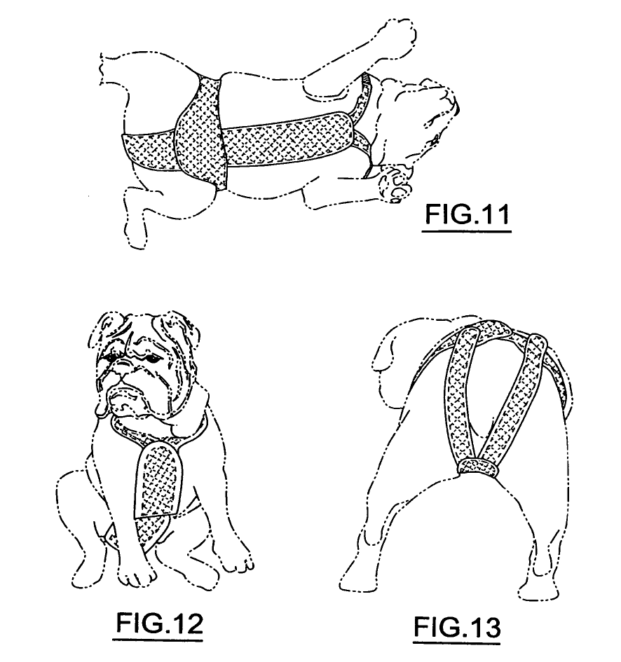

FIGS. 9-13 illustrate the robustness of the present invention in being fitted to a dog with different body proportions than the dog of FIGS. 5-7.

As a result of the improved structure of the pet diaper system of the present invention, a quick and easy application of the system on a pet is achieved which is more tolerable for the animal. The pet caretaker applies a disposable absorbent pad to the pad-receiving area on the longitudinal portion of the cross support. The girth portion is then wrapped around the body or waist of the animal and the distal ends of the girth portion are fastened at the top side of the animal. The rear straps are introduced through the hind legs of the animal and around the tail of the animal to its top side. The distal ends of the rear straps are attached to the girth portion at the top side of the animal (preferably to the fasteners at the rear edge of the girth portion). The suspender straps are then introduced between the front legs of the animal and around its neck. The suspender straps are preferably crossed over and then attached at the intermediate portions thereof. The distal ends of the suspender straps are attached to the girth portion at the top side of the animal (preferably to the fasteners at the front edge of the girth portion).

What is claimed is:

1. An animal diaper system for retaining a disposable absorbent pad against an animal, comprising:
a cross support having a girth portion and a longitudinal portion, said girth portion having attachable distal ends for securing said girth portion around said animal, said longitudinal portion extending from said girth portion and having a tail end and a front end for fitting along the underside of said animal, said longitudinal portion comprising a pad-receiving area between said tail end and said girth portion;
left and right rear straps connected to said tail end and having attachable distal ends, said rear straps adapted to pass between the hind legs of said animal and around respective sides of the tail of said animal to attach to said girth portion at the top side of said animal; and
a pair of suspender straps connected to said front end and having attachable distal ends, said suspender straps adapted to pass around respective sides of the neck of said animal to attach to said girth portion at the top side of said animal, said suspender straps having attachable intermediate sections for joining together at a position along said top side of said animal between the neck and said girth portion.

2. The system of claim 1 wherein said cross support is comprised of cotton quilted fabric.

3. The system of claim 1 wherein said girth portion tapers outward from said longitudinal portion to said attachable distal ends, thereby providing a contour around the hind legs of said animal.

4. The system of claim 1 wherein said girth portion further comprises hook and loop fasteners at said attachable distal ends.

5. The system of claim 1 wherein said attachable distal ends of said rear straps include first and second hook and loop fasteners, and wherein said girth portion includes a third and fourth hook and loop fasteners on an exterior side thereof for receiving said first and second hook and loop fasteners.

6. The system of claim 1 wherein said attachable distal ends of said suspender straps include fifth and sixth hook and loop fasteners, and wherein said girth portion includes a seventh and eighth hook and loop fasteners on an exterior side thereof for receiving said fifth and sixth hook and loop fasteners.

7. The system of claim 1 wherein said suspender straps further include ninth and tenth hook and loop fasteners, respectively, at said position in said intermediate sections.

8. The system of claim 1 wherein said suspender straps are further comprised of adjustable cinches for adjusting the effective length of said suspender straps.

9. The system of claim 1 wherein said suspender straps are further comprised of elastic band sections wherein said suspender straps are stretchable.

10. The system of claim 9 wherein said elastic band sections include elastic bands between said distal ends of said suspender straps and said intermediate sections.

11. The system of claim 9 wherein said elastic band sections include elastic bands between said intermediate sections and said front end of said longitudinal portion.

12. The system of claim 9 wherein said elastic band sections include elastic bands between said distal ends of said suspender straps and said intermediate sections and between said intermediate sections and said front end of said longitudinal portion.

13. The system of claim 1 wherein said cross support further comprises elastic bands connected between said girth portion and said front end of said longitudinal portion.

14. A method of fitting a diaper system to an animal, wherein said diaper system includes a cross support having a girth portion and a longitudinal portion, left and right rear straps connected to a tail end of said longitudinal portion, and a pair of suspender straps connected to a front end of said longitudinal portion, said method comprising the steps of:
applying a disposable absorbent pad to a pad-receiving area of said longitudinal portion of said cross support;
joining distal ends of said girth portion at the top side of said animal to fasten said girth portion around the body of said animal;
introducing said rear straps through the hind legs of said animal and around the tail of said animal to said top side of said animal;
attaching distal ends of said rear straps to said girth portion at said top side of said animal;
introducing said suspender straps between the front legs of said animal and around the neck of said animal;
crossing over said suspender straps and attaching them at intermediate portions thereof; and
attaching distal ends of said suspender straps to said girth portion at said top side of said animal.

15. The method of claim 14 wherein said attaching steps are each comprised of joining respective hook and loop fasteners.
